(19) United States
(12) Patent Application Publication
(10) Pub. No.: US 2015/0133256 A1
(43) Pub. Date: May 14, 2015

(54) LANTERN-TYPE GEAR UNIT

(71) Applicant: iwis motorsysteme GmbH & Co. KG, Munchen (DE)

(72) Inventors: Michael FRANK, Otterfing (DE); Alexander SALZSEILER, Munchen (DE); Andreas OTT, Munchen (DE); Christophe LUNK, Munchen (DE)

(21) Appl. No.: 14/533,958

(22) Filed: Nov. 5, 2014

(30) Foreign Application Priority Data
Nov. 8, 2013 (DE) 102013018775.3

(51) Int. Cl. F16H 1/32; F16H 55/10; F01L 1/352

(52) U.S. Cl. CPC F16H 1/32; F01L 1/352; F16H 55/10
USPC 475/167

(57) ABSTRACT

A lantern-type gear unit, in particular for a camshaft adjuster, comprising at least two meshing gear wheels, a first gear wheel being configured as a lantern gear wheel and a second gear wheel including a lantern gear ring that engages with the lantern gear wheel. The lantern gear ring comprises at least one first annular bolt holder and a plurality of bolts arranged on the boundary of the bolt holder. The annular bolt holder has, together with the bolts, a circumferential contour that is overlap-free with respect to the lantern gear wheel in an axially parallel direction, so that the annular bolt holder can, together with the bolts, be assembled with the lantern gear wheel in an axially parallel direction. A camshaft adjuster for an internal combustion engine comprising such a lantern-type gear unit is also provided.

### CROSS-REFERENCE TO RELATED APPLICATION

This application claims priority to foreign German patent application No. DE 102013018775.3, filed on Nov. 8, 2013, the disclosure of which is incorporated by reference in its entirety.

### FIELD OF THE INVENTION

The present invention relates to a lantern-type gear unit comprising at least two meshing gear wheels, a first gear wheel being configured as a toothed lantern gear wheel and a second gear wheel including a lantern gear ring that engages with the lantern gear wheel, said lantern gear ring comprising at least one first annular bolt holder and a plurality of bolts arranged on the boundary of the bolt holder. In addition, the invention relates to a corresponding camshaft adjuster for an internal combustion engine.

### BACKGROUND

Conventional gear units, no matter whether they are configured as toothed gearings, planetary gearings or eccentric gearings, are used in the prior art as single- or multi-stage gearings for a great variety of applications. In addition to the actual toothed gearings, also planetary gearings or eccentric gearings may comprise toothed gear wheels and include, in addition to shafts held stationary with respect to the frame, which do not change their position in the gear casing, also revolving shafts that revolve eccentrically in the gearing. Such gear units necessitate, especially in the case of multi-stage gearings or high gear ratios, in addition to an accurate construction, also high precision as regards the manufacturing and mounting of the gear wheels so as to allow the gear unit to operate accurately and with the least possible amount of friction. In order to avoid such complicated manufacturing and mounting of toothed gear wheels with precision-ground teeth, it is known in the prior art to provide gear units with lantern gear elements and toothed lantern gear wheels.

Gear units with lantern gear elements are used not only for a mere transmission of a rotary movement but also as summation or distribution gearings. Since planetary gearings always comprise at least two shafts held stationary with respect to the frame as well as a revolving shaft, summation gearings having a gearing that comprises at least two stages and a comparatively high gear ratio can easily be realized in this way. Other than planetary gearings, eccentric gearings already allow a high gear ratio on the basis of a single-stage gearing.

Planetary gearings as well as eccentric gearings are often used as camshaft adjusters, which allow the valve opening times to be adapted to the load behaviour of internal combustion engines during operation of the engine. By changing the overlap times of the exhaust valves and intake valves, such camshaft adjusters can be used not only for reducing the amount of fuel consumed and for accomplishing an increase in performance and torque but also for reducing emissions, which, in view of the continuously increasing demands on the fulfillment of exhaust emission standards, is an important aspect. In addition to various gear units also hydraulic swing motors are used as camshaft adjusters. Such hydraulic camshaft adjusters are commonly used and are driven via the engine oil circuit. Hence, the function of the camshaft adjuster depends on the pressure and the temperature of the engine oil.

A generic lantern-type gear unit is known from DE 10 2012 013 637 A1, in which the planets of an epicyclic gearing, which are configured as toothed lantern gear wheels, engage the sun wheels and annulus wheels configured as lantern gear elements formed on the basis of inner chain links. Also DE 24 14 730 A1 discloses a gear unit with a chain-based lantern gear element engaged by an eccentrically supported lantern gear wheel. DE 41 10 195 A1 and DE 102 48 355 A1 disclose electrically driven camshaft adjusters in the case of which an adjustment of the relative angle of rotation of the camshaft to the camshaft wheel is accomplished by means of a planetary gearing or an eccentric gearing.

In spite of synergies with chain technology, the lantern-type gear units known from the prior art, which are intended to simplify production and reduce production costs in comparison with conventional gear units comprising precision-ground gears, still entail problems as regards the production of the lantern gear elements as well as the fixing and mounting of the latter in the gear unit. It is therefore still necessary to further improve the construction, the manufacturing and the assembly of lantern-type gear units so as to improve the competitiveness of such constructions in comparison with conventional gear units.

### SUMMARY OF THE INVENTION

It is therefore the object of the present invention to provide a lantern-type gear unit for improving the problems of gear units with lantern gear elements that are known to exist in the prior art.

For a generic lantern-type gear unit, this object is achieved in that the annular bolt holder has, together with the bolts, a circumferential contour that is overlap-free with respect to the lantern gear wheel in an axially parallel direction, so that the annular bolt holder can, together with the bolts, be assembled with the toothed lantern gear wheel in an axially parallel direction. The overlap-free axial mountability of the annular bolt holder in a pre-assembled gear unit, e.g. in a camshaft adjuster of an internal combustion engine, offers high ease of mounting during the gear unit assembly operation and, in the case of worn components, the possibility of easily replacing component parts. The lantern gear wheel is configured as a toothed gear wheel having a tooth contour that is configured for engaging with a lantern gear element. As is usually the case with lantern gear elements, the bolts project perpendicularly from a side face of the annular bolt holder, which may in particular by configured as a circumferentially extending, one-piece, continuously closed and flat annular disk. Such a flexurally rigid, self-supporting ring allows the bolts to be fixedly arranged relative to the second gear wheel. Though configured as part of a lantern-type gear unit, the circumferential contour of the annular bolt holder with the bolts, which is overlap-free in an axially parallel direction, allows an axially floating arrangement of the second gear wheel, configured as a lantern gear element, relative to the toothing of the first gear wheel that is configured as a lantern gear wheel. The number of bolts, which are usually arranged in a uniform and in particular also circular manner on the at least one first annular bolt holder and which are thus fixed relative to the second gear wheel, corresponds to the number of teeth of conventional toothed gear wheels. Separately formed bolts may here be fixed by rivets in respective bolt holes of the annular bolt holder. Alternatively, the lantern gear ring may also be configured as a one-piece component, e.g. as a sintered component part in the case of which the bolts are formed integrally with the bolt holder. Making use of this lantern-type gear unit according to the present invention, planetary gearings, eccentric gearings or similar type of gearings, which may be configured as single or multiple stage gearings, can be realized.

According to an expedient embodiment, the bolts additionally comprise bolt pins with at least one of sleeves and rollers, said sleeves and rollers enclosing the bolt pins. In addition to simple bolts, which may have a smaller diameter at their bolt ends for arrangement in the bolt hole of the annular bolt holder, also the bolt pins may be configured as hollow bolts or solid bolts. Configuring the bolts of the lantern gear ring as bolt pins with sleeves and rollers allows a simple realization of a larger outer diameter beyond the bolt holder contour. In addition, the use of at least one of sleeves and rollers that are arranged around the bolt pins allows a reduction of wear on the surfaces engaging or contacting the lantern gear wheel. In contrast to the rollers, which are normally rotatably arranged on the sleeves or directly on the bolt pins, the sleeves are usually press fitted onto the bolt pins. In special cases of use, the sleeves may alternatively also be arranged on the bolt pins in a loose fit or a transition fit. In the case of lantern-type gear units comprising an eccentrically supported gear wheel, rollers are frequently used so as to reduce the increased amount of wear in the eccentric gearing. For optimizing the structural design of the gearing, the axial length of the sleeves and rollers may be chosen in accordance with the load occurring in the lantern-type gear unit according to the present invention and the demands on a compact structural design of the gearing.

For forming an overlap-free circumference contour, the annular bolt holder has, on a first circumferential surface facing the lantern gear wheel, a tooth-shaped or wave-shaped contour with protruding areas and recessed areas. For arranging the bolts on the annular bolt holder in a simple manner, the protruding areas of the first circumferential surface may be configured as bolt hole eyes, and the bolts or the bolt pins may be secured in position in the bolt holes of the bolt hole eyes. For allowing, in spite of the fact that the circumferential contour of the bolt holder with bolts is overlap-free in an axially parallel direction, the lantern gear wheel to engage with the lantern gear ring with the least possible amount of play, the outer diameter of the bolt hole eye may, on the protruding areas of the first circumferential surface of the annular bolt holder, be smaller than or equal to the outer diameter of the bolts and the outer diameter of the sleeve or roller on a bolt pin, respectively.

According to an advantageous embodiment, the protruding areas of the first circumferential surface of the annular bolt holder extend over at least 120°, preferably over at least 180° of the circumference of the bolts. It follows that, from a bolt hole eye diameter or bolt diameter of 120°, preferably 180° onwards, the first circumferential surface of the annular bolt holder is recessed, in the area between the bolt hole eyes, relative to the protruding areas of the circumferential contour. This shape of the first circumferential surface allows, although no overlaps are formed in an axially parallel direction, a sufficiently large overlap area for engagement between the lantern gear wheel and the lantern gear ring.

According to a preferred embodiment, the recessed areas of the first circumferential surface of the annular bolt holder may be recessed more deeply or further down than the tip circle of the lantern gear wheel engaging with the lantern gear ring. The annular bolt holder with bolts can thus be mounted reliably relative to the lantern gear wheel in an axially parallel direction without any radial play occurring in the gear unit. According to a further embodiment, the recessed areas of the first circumferential surface of the annular bolt holder are recessed more deeply than the midpoint circle of the bolts on the annular bolt holder. Such a distinct shape of the wave- or tooth-shaped circumferential contour allows, in addition to the reliable axially parallel mounting of the lantern gear ring, also a reliable engagement between the lantern gear wheel and the lantern gear ring bolts fixed in position by the annular bolt holder.

According to a special embodiment, the second gear wheel additionally comprises a base body with a radial lantern gear ring reception means, so that the annular bolt holder can, together with the bolts, be mounted in the radial lantern gear ring reception means of the base body in an axially parallel direction. The formation of a base body allows an overlap-free axial mountability of the lantern gear ring also with respect to a fully mounted base body of the second gear wheel. The annular bolt holder is here configured such that it is overlap-free also with respect to the lantern gear ring reception means in an axially parallel direction and, accordingly, it is accommodated in the lantern gear ring reception means in an axially floating manner. The lantern gear ring and the base body of the second gear wheel can thus be implemented as separate component parts, which can be produced independently of one another and mounted independently of one another when the gear unit is being assembled. The overlap-free axial mountability also allows a simple replacement of the respective component parts in the case of wear.

According to an expedient embodiment, an axial fixing unit may be provided, by means of which the annular bolt holder can be fixed in position in the radial lantern gear ring reception means so as to avoid an undesired axial movement of the lantern gear ring during operation. For reliably transmitting the rotary movement from the lantern gear ring to the base body of the second gear wheel, the radial lantern gear ring reception means may comprise a circumferentially extending, radial, form-fit connection surface, the lantern gear ring being connected to the base body in a rotationally fixed manner via the circumferentially extending, form-fit connection surface. For simple, axially parallel mounting of the lantern gear ring it will be of advantage when the circumferentially extending, form-fit connection surface of the base body extends parallel to the axis of the second gear wheel. Such a circumferentially extending, form-fit connection surface reduces the demands on the fitting accuracy of the lantern gear ring reception means and of the annular bolt holder, so that the manufacturing tolerances can be reduced.

According to a preferred embodiment, the annular bolt holder of the lantern gear ring has a second circumferential surface, which is in form-fit or force-fit contact with the circumferentially extending, form-fit connection surface of the base body so as to connect the base body and the lantern gear ring in a rotationally fixed manner. Such a form-fit or force-fit contact between the form-fit connection surface of the base body and the second circumferential surface of the bolt holder, no matter whether provided as frictional contact or as a complementary shape, offers a simple solution for transmitting the movement of the lantern gear wheel to the base body and thus to the second gear wheel.

For accomplishing the smallest possible overall size of the annular bolt holder and consequently of the gear unit in its entirety, the second circumferential surface of the annular bolt holder may have a wave-shaped profile, the respective wave crests being associated with the bolt holes in the bolt holder. The wave crests of the second circumferential surface in the area of the bolt hole eyes enlarge there the undisturbed material of the annular bolt holder, so that the annular bolt holder always has a certain minimum width along its whole circumference. Accordingly, the wave crests compensate the weakening of the bolt holder caused by the bolt holes in the area of the bolt hole eyes and guarantee a high basic strength in spite of the comparatively small width of the annular bolt holder. The overall size of the lantern gear ring can thus be kept small. Alternatively, the second circumferential surface may have a wave-shaped profile which is independent of the bolt holes in the bolt holder and which has a respective identical second circumferential surface in the case of different embodiments of the lantern gear ring, in spite of different numbers of bolts, so as to realize different gear ratios on the basis of the same base body and the same basic structural design of the gear unit.

According to an expedient embodiment, the lantern gear ring is provided with additional annular bolt holders, the bolts being positioned between two annular bolt holders arranged in parallel spaced relationship with one another. These two annular bolt holders are arranged in spaced relationship with one another and are fixedly connected to one another via the bolts for allowing a simple, reliable and cost-saving structural design of the lantern gear ring. During operation, it is thus possible to distribute the forces acting on the bolt holder to two spaced-apart annular bolt holders. The first bolt holder as well as the second bolt holder may by produced as blanked parts in a simple manner.

According to a special embodiment, the track width of the lantern gear wheel is larger than the length of the bolt portions protruding from the at least one first annular bolt holder. Due to the overlap-free circumferential contour of the annular bolt holder with bolts relative to the lantern gear wheel, the lantern gear wheel can extend into the area of the annular bolt holder and can thus be broader or thicker in the axial direction than the length of the free portion of the bolts or of the sleeves or rollers. Force can thus be transmitted over the entire free length of the bolts and this, in turn, contributes to a reduction of the risk of breakage of the lantern gear ring.

According to another embodiment, the gear unit is configured such that it comprises at least two stages with at least two lantern gear wheels and at least two lantern gear rings, which each engage with one of the lantern gear wheels, the lantern gear rings each comprising at least one first annular bolt holder and a plurality of bolts, and the annular bolt holder and the bolts of the lantern gear rings having, in an axially parallel direction, an overlap-free circumferential contour with respect to the lantern gear wheel engaging with the respective lantern gear ring. Irrespectively of whether the gear unit is configured as an eccentric gearing or as a planetary gearing, a two-stage gear unit allows a very high gear reduction and, consequently, very good self-locking of the gear unit.

The present invention also relates to a camshaft adjuster for an internal combustion engine with a lantern-type gear unit according to the present invention. Although the components used are of a very simple nature, a camshaft adjuster of this type allows a reliable adjustment of the angle of rotation of the camshaft relative to the camshaft wheel of an internal combustion engine, said camshaft wheel being held stationary relative to the crankshaft.

### BRIEF DESCRIPTION OF THE DRAWINGS

In the following, an embodiment of the lantern-type gear unit will be explained in more detail making reference to drawings, in which:

FIG. 1 shows a partially exposed perspective view of a lantern-type gear unit according to the present invention, said lantern-type gear unit being configured as a two-stage unit,

FIG. 2 shows a top view of a stage of the lantern-type gear unit according to FIG. 1,

FIG. 3 shows a detail view of the lantern-type toothing according to FIG. 2,

FIG. 4 shows a perspective exploded view of the annulus gear comprising a base body and a lantern gear ring of a stage of the lantern-type gear unit according to FIG. 2,

FIG. 5 shows a perspective detail view of the lantern gear ring according to FIG. 4 and

FIG. 6 shows an enlarged side view of a portion of the lantern gear ring according to FIG. 5.

### DETAILED DESCRIPTION

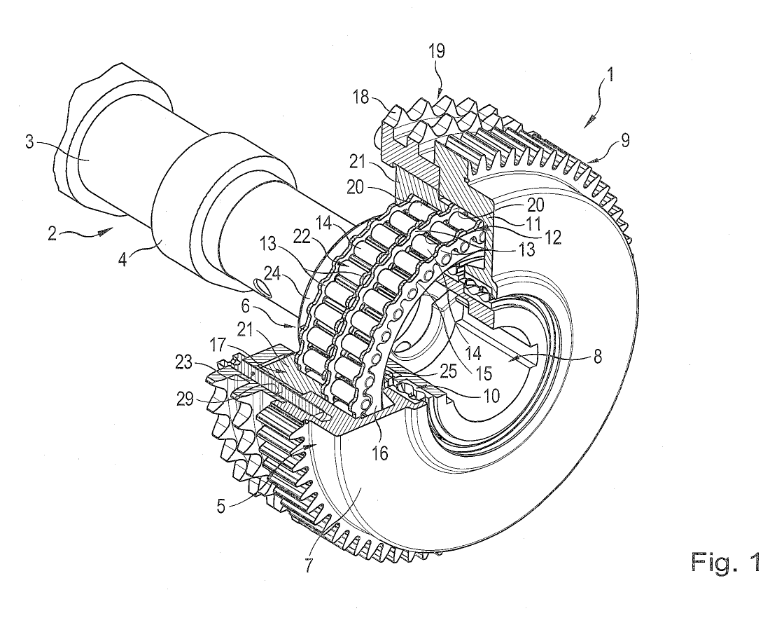

The perspective, partially exposed view according to FIG. 1 shows an embodiment of a lantern-type gear unit 1 according to the present invention, which, in the embodiment shown here, is used as a camshaft adjuster 2 of an internal combustion engine. For this purpose, the gear unit 1 is arranged on one end of a camshaft 3 and allows a rotary movement, which is imparted via the gear unit 1, to be transmitted to the control valves (not shown) of the internal combustion engine via the valve cams 4. As can clearly be seen from the exposed portion of the gear unit 1, this lantern-type gear unit 1 is configured as a two-stage gear unit, the first gear stage 5 being arranged on the gear unit side facing away from the camshaft 3 and the second gear stage 6 being arranged on the gear unit side facing the camshaft 3.

In accordance with the formation of this two-stage lantern-type gear unit 1 as an eccentric gearing, the first gear stage 5 comprises an annulus gear 7, which is supported on an inner hub 8 for connection to an electric motor (not shown) and which closes the gear unit 1 on the side. For supporting the annulus gear 7 on the inner hub 8, a double ball bearing 10 is provided, on which an enlarged base of the annulus gear 7 of the first gear stage 5 rests. The outer circumference of the annulus gear 7 has formed thereon the teeth of a drive gear 9 through which an auxiliary drive (not shown) can be driven. The annulus gear 7 of the first gear stage 5 fundamentally comprises a base body 11 that forms the base used for supporting the annulus gear 7 on the double ball bearing 10, the continuous side face of the annulus gear 7 as well as the drive gear 9 that projects beyond the circumference. On the inner side of the outer circumference of the base body 11 of the first gear stage 5, a lantern gear ring 12 is arranged, which comprises two spaced-apart annular bolt holders 13 and a plurality of bolts 14, said bolts 14 fixing the annular bolt holders 13 in parallel spaced relationship with each other. In the exposed area of the lantern-type gear unit 1 shown in FIG. 1, the bolts 14 of the lantern gear ring 12 as well as part of the first circumferential contour 15 of the annular bolt holders 13 are in engagement with the lantern gear wheel 16 of the first gear stage 5, said lantern gear wheel 16 revolving eccentrically with respect to the axis of rotation of the camshaft 3 (here not shown).

The second gear stage 6 provided on the side of the lantern-type gear unit 1 facing the camshaft 3 has, in accordance with the first gear stage 5, a second annulus gear 17 on the side of the lantern-type gear unit 1 facing the camshaft 3. Also the annulus gear 17 of the second gear stage 6 closes the gear unit 1 on the side, but it is fixedly coupled to the camshaft 3. The outer circumference of the annulus gear 17 has provided thereon a traction-means camshaft wheel 19 with two chain wheel toothings 18 that are arranged in parallel. The camshaft wheel 19 arranged on the level of the annulus gear 17 is configured for engaging a duplex timing chain (not shown). Also the annulus gear 17 of the second gear stage 6 comprises a base body 21 forming, in addition to a continuous side face used for closing the gear unit 1 on the side, also a lantern gear ring reception means 20 for accommodating the lantern gear ring 22 of the second gear stage 6. In addition, a plurality of fixing screws 23 extend through the camshaft wheel 19 that is supported such that it is rotatable relative to the base body 21 of the second gear stage 6, said fixing screws 23 securing the camshaft wheel 19 to the base body 11 of the first gear stage 5 such that it is secured against rotation relative thereto.

As can easily be seen in FIG. 1, the components of the lantern-type gear unit 1 according to the present invention, which is here configured as a two-stage eccentric gearing, are adapted to be mounted one after the other in an axially parallel direction. Since all the components fit together without overlapping one another in the axial direction, it is possible to axially mount the whole lantern-type gear unit 1 on the camshaft 3 in one operational procedure making use of the components provided and to disassemble it completely. The end of the camshaft 3 facing the gearing has provided thereon an end flange 24 on which the base body 21 of the annulus gear 17 of the second gear stage 6 abuts and which facilitates a reliable connection to the camshaft 3.

When the lantern-type gear unit 1 is being assembled, the base body 21 of the second gear stage 6 is therefore first mounted such that the radial reception means 27 abuts on the end flange 24 of the camshaft 3. During a preliminary mounting step, the base body 21 had already been provided with the lantern gear ring 22 of the second gear stage 6, which was inserted in the lantern gear ring reception means 20 of the base body 21 in an axially parallel direction. In the next step, the lantern gear wheel 26 of the second gear stage 6 is, together with the inner hub 8 and an eccentric bearing 28 supported on the eccentric portion 25 thereof, positioned in the lantern gear ring 22. Through insertion of the lantern gear ring 22 into the lantern gear ring reception means 20 of the base body 21 and through the subsequent insertion of the lantern gear wheel 26, the lantern gear ring 22 also engages the toothing of the lantern gear wheel 26 in certain areas thereof. Since the annular bolt holders 13 with the bolts 14 are configured such that axial overlapping with the lantern gear wheel 26 does not take place in an axially parallel direction, the axial mountability of the lantern gear wheel 26 is nevertheless not impaired by the lantern gear ring 22. When the lantern gear wheel 26 has been inserted into the lantern gear ring 22 of the second gear stage 6 and when the lantern gear ring 22 simultaneously engages the toothing of the lantern gear wheel 26 and the lantern gear ring reception means 20 of the annulus gear 17, the second gear stage 6 of the lantern-type gear unit 1 is ready to operate.

The eccentric portion 25 of the inner hub 8, which is arranged such that it is rotatable relative to the camshaft 3 and on which also the lantern gear wheel 26 of the second gear stage 6 may be supported via the eccentric bearing 28, has first axially mounted thereon the lantern gear wheel 16 of the first gear stage 5. The lantern gear wheel 16 of the first gear stage 5 and the lantern gear wheel 26 of the second gear stage 6 may be configured as one-piece or two-piece components, but they must be configured such that they are prevented from rotating relative to one another. The eccentric portion 25 thus allows the two lantern gear wheels 16 and 26 to wobble simultaneously about the axis of rotation D. In a last step, the annulus gear 7 of the first gear stage 5, in which the lantern gear ring 12 is already arranged in a form fit manner in the base body 11 in the radial reception means 20 thereof, is mounted on the lantern gear wheel 16 of the first gear stage 5 in an axially parallel direction, the toothing of the lantern gear wheel 16 engaging then the first circumferential contour 15 of the lantern gear ring 12 in certain areas thereof, said first circumferential contour 15 being defined by the bolt holders 13 and the bolts 14. When the annulus gear 7 of the first gear stage 5 is being axially attached, said annulus gear 7 is simultaneously brought into form-fit engagement with the traction-means camshaft wheel 19 which is rotatably attached to the base body 21 of the second gear stage 6, so that the annulus gear 7 can then be fixed to the camshaft wheel 19 by means of a plurality of fixing screws 23 extending through respective mounting holes 29 in the camshaft wheel 19.

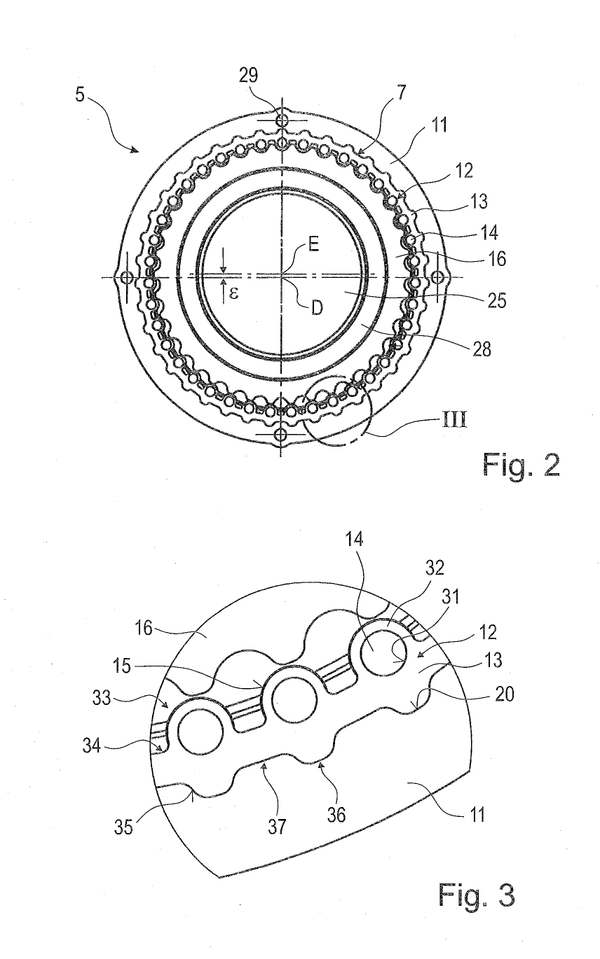

In the top view of the first gear stage 5 of the lantern-type gear unit 1 shown in FIG. 2, it can clearly be seen that the circular eccentric portion 25 of the inner hub 8 has an eccentric axis E, which, though extending concentrically with the eccentric portion 25, is nevertheless arranged such that it is displaced relative to the axis of rotation D by the eccentricity c, which means that it is also eccentric with respect to the annulus gear 7 comprising the base body 11 and having the lantern gear ring 12 arranged therein. In the representation according to FIG. 2, the inner contour of the inner hub 8 is not shown for reasons of clarity. During each rotary movement of the inner hub 8 relative to the annulus gear 7, a change of position of the axis E relative to the axis of rotation D takes place, so that the eccentric axis E of the circular eccentric portion 25 wobbles about the axis of rotation D with the eccentricity ε during a rotary movement. On the circumference of the circular eccentric portion 25, a bearing seat is provided on which the eccentric bearing 28 is arranged, the lantern gear wheel 16 and, optionally, also the lantern gear wheel 26 being then supported on said eccentric bearing 28 such that it is/they are rotatable relative to the eccentric portion 25. Due to the coaxial arrangement of the inner hub 8 and of the camshaft 3, also the lantern gear wheels 16, 26 wobble, together with the eccentric portion 25, about the axis of rotation D of the camshaft 3 with the eccentricity ε.

As has already been explained, a change of position of the eccentric axis E relative to the axis of rotation D of the camshaft 3 takes place during each rotary movement of the circular eccentric portion 25 relative to the annulus gear 7, so that also the eccentric bearing 28 supported on the eccentric portion 25 as well as the lantern gear wheels 16, 26 positioned on the eccentric bearing 28 wobble. Accordingly, also the sectionwise engagement between the toothing of the lantern gear wheel 16 and the lantern gear ring 12 moves along the circumference of the lantern gear ring 12. The engagement between the lantern gear wheel 16 and the lantern gear ring 12, which only takes place in certain areas, results from the eccentric arrangement of the lantern gear wheel 16 in the first gear stage 5 by means of the eccentric portion 25. The lantern gear wheel 16, which is arranged on the eccentric bearing 28 such that it is displaced by the eccentricity ε relative to the axis of rotation D of the camshaft 3 and of the annulus gear 7, has the effect that the toothing of the lantern gear wheel 16 in FIG. 2 engages with the lantern gear ring 12 of the annulus gear 7 only in the upper area of FIG. 2. On the opposite side, a gap is formed between the toothing of the lantern gear wheel 16 and the lantern gear ring 12. As can be seen in FIG. 3, which shows detail III of FIG. 2, the distance between the toothing of the lantern gear wheel 16 and the lantern gear ring 12, which is approximately twice as large as the eccentricity ε, just suffices for positioning the toothing of the lantern gear wheel 16 and the lantern gear ring 12 such that they do not overlap, although the number of teeth of the lantern gear wheel 16 differs from the number of bolts 14 of the lantern gear ring 12.

In the detail view according to FIG. 3, also the shape of the annular bolt holder 13 of the lantern gear ring 12 can clearly be seen. For arranging the bolts 14 on the annular bolt holder 13, a plurality of bolt holes 31 is provided, said bolt holes 31 defining respective bolt hole eyes 32 in the flat annular disk of the bolt holder 13. Thus, a gear-shaped or wave-shaped first circumferential surface 30 is formed on the annular bolt holder 13. Accordingly, the first circumferential surface 30 around the bolt hole eyes 32 of the annular bolt holder 13 defines, together with the bolts 14, the first circumferential contour 15 of the lantern gear ring 12, said first circumferential contour 15 facing the toothing of the lantern gear wheel 16 and contacting the same in sectionwise engagement therewith. The bolt hole eyes 32 define, together with the associated bolts 14, protruding areas 33 of the first circumferential contour 15, whereas complementary recessed areas 34 are formed by the bolt hole eyes 32 between two protruding areas 33. On the side of the annular bolt holder 13 facing away from the first circumferential contour 15, a wave-shaped second circumferential contour 35 is provided, the wave crests 36 and wave troughs 37 of said second circumferential contour 35 being accommodated in a form fit manner in the lantern gear ring reception means 20 of the base body 11 of the annulus gear 7 of the first gear stage 5. For allowing the lantern gear ring 12 to be mounted in the base body 11 in an axially parallel direction, the second circumferential contour 35 of the lantern gear ring 12 is configured such that it does not overlap the lantern gear ring reception means 20 of the base body 11 in the axial direction.

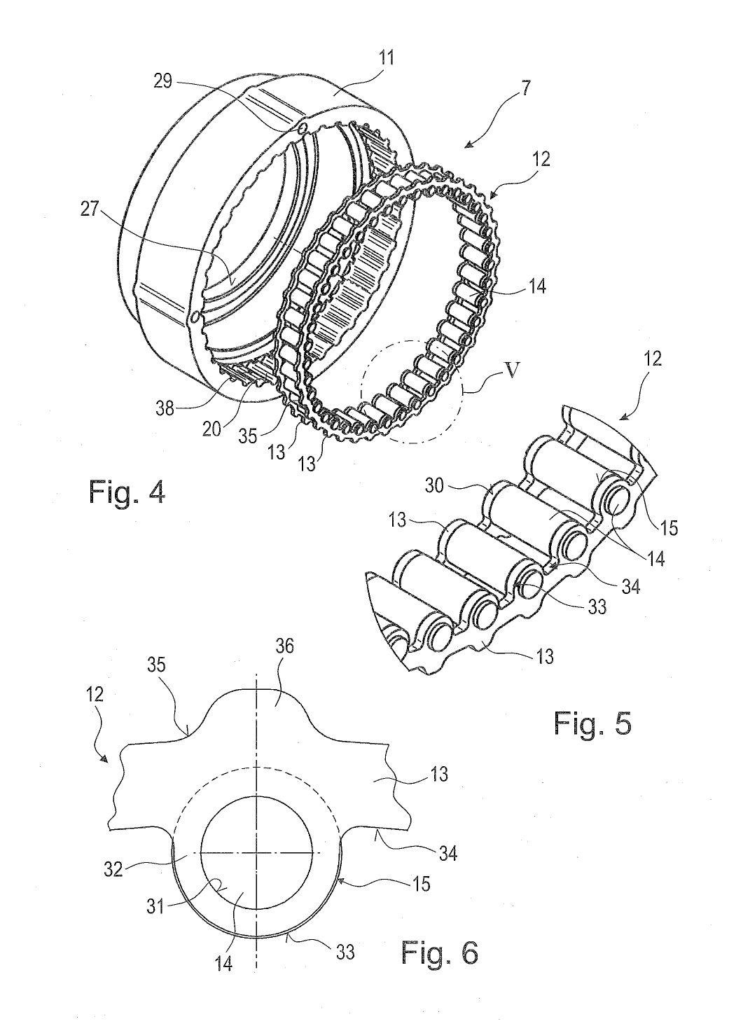

The exploded view of the annulus gear 7 of a first gear stage 5 of a gear unit 1 in FIG. 4 shows again clearly that the second circumferential contour 35 of the lantern gear ring 12 is configured such that it does not overlap the radial connection surface 38 of the lantern gear ring reception means 20, said radial connection surface 38 being also wave-shaped and said overlap-free structural design being accomplished by the wave-shaped form of the annular bolt holders 13. The lantern gear ring 12 can thus easily be mounted in the base body 11 in an axially overlap-free manner, and the fact that the second circumferential contour 35 of the lantern gear ring 12 is accommodated in a form fit manner in the circumferentially extending radial connection surface 38 of the lantern gear ring reception means 20 guarantees a reliable transmission of the rotary movement in the gear unit 1. The annulus gear 7 is supported on the double ball bearing 10 via the radial reception means 27. On the outer circumference of the base body 11, the drive gear 9, through which an auxiliary drive can be driven, can clearly be seen.

The side view of detail V of the lantern gear ring 12 in FIG. 5 discloses again more precisely the first circumferential contour 15 of the lantern gear ring 12 obtained from the combined effect of the annular bolt holders 13 and the bolts 14, which are arranged as one-piece bolts with tapering ends for insertion in the bolt holes 31 of the annular bolt holders 13 or as multi-part bolt elements with thinner bolt pins that are arranged in the bolt holes 31, as well as sleeves and/or rollers, which are arranged on the bolt pins in the area between the two annular bolt holders 13 and which define the outer circumference of the bolts 14. As can clearly be seen in the detail view according to FIG. 5, the outer circumference of the bolts 14 is flush with the circumference of the annular bolt holders 13 in the protruding areas 33 of the lantern gear ring 12, so that the first circumferential contour 15 is formed by the circumference of the bolt holders 13 and the outer circumference of the bolts 14 in common. This can clearly be seen once more in the enlarged top view of a bolt hole eye 32 in FIG. 6. In this detail view, it can be seen that the outer circumference of the bolts 14 may even be slightly larger than, but at least as large as the contour of the first circumferential surface 30 of the bolt holder 13 in the area of the bolt hole eyes 32. Accordingly, the first circumferential contour 15 of the lantern gear ring 22 is formed by the outer circumference of the bolts 14, in the region of the protruding areas 33, and the contour of the annular bolt holders 13, in the region of the recessed areas 34, in common.

In the following, the mode of operation of a lantern-type gear unit 1 according to the present invention and of a corresponding camshaft adjuster 2 will be explained in more detail.

When the lantern-type gear unit 1 according to the present invention is in operation, a rotary movement imparted to the camshaft wheel 19 is transmitted via the annulus gear 17 coupled thereto, the lantern gear ring 12 and the lantern gear wheel 16 of the first gear stage 5 to the lantern gear wheel 26, the lantern gear ring 22 and the annulus gear 17 of the second gear stage 6 and then to an output shaft, e.g. the camshaft 3 of an internal combustion engine, so as to transmit the rotary movement of a main drive, e.g. the movement of a crankshaft (not shown) of an internal combustion engine, when the gear unit 1 is used as a camshaft adjuster 2. The position which the annulus gears 7, 17 and the lantern gear wheels 16, 26 of the first and second gear stages 5, 6 occupy relative to one another does not change in the course of this process.

For adjusting the angle of rotation between the annulus gear 17 of the second gear stage 6, according to the camshaft 3 arranged on the annulus gear 17, and the camshaft wheel 19 rotatably arranged on said camshaft 3, an additional rotary movement is imparted to the gear unit 1 via the inner hub 8. To this end, the inner hub 8 has attached thereto a suitable drive, normally an electric motor rotating therewith. Via the rotary movement of a circular eccentric portion of the inner hub 8, which takes place eccentrically to the axis of rotation D of the camshaft 3, also the lantern gear wheel 16, which is also supported eccentrically to the axis of rotation D, is caused to wobble about the axis of rotation D. Since the lantern gear wheel 16 engages with the lantern gear ring 12 only in certain areas thereof, the lantern gear wheel 16 rolls on the lantern gear ring 12 once during one revolution of the eccentric portion of the first gear stage 5. In the course of this movement, the lantern gear wheel 16 and the lantern gear ring 12 and the annulus gear 7 associated therewith as well as the camshaft wheel 19 coupled thereto move relative to one another by the difference between the number of teeth of the lantern gear wheel 16 and the bolts 14 of the lantern gear ring 12. Whereas the lantern gear wheel 16, cf. also FIG. 2, engages on one side thereof the bolts 14 of the lantern gear ring 12, a gap corresponding to approximately twice the eccentricity ε is formed on the opposite side between the toothing of the lantern gear wheel 16 and the lantern gear ring 12. The gap prevents the bolts 14 of the lantern gear ring 12 from overlapping the toothing of the lantern gear wheel 16 and thus allows the lantern gear wheel 16 to rotate eccentrically.

When an electric motor rotating together with the inner hub 8 is used, the co-rotating rotor of the electric motor is accelerated or decelerated on the inner hub 8 for adjusting the angle of rotation between the annulus gear 7 of the first gear stage 5 and an output shaft, according to a rotary angle adjustment between the camshaft wheel 19 and the camshaft 3 of a camshaft adjuster 2, so that the position of the eccentric portion 25 of the inner hub 8 will change relative to the lantern gear wheel 16. During a movement of the eccentric portion 25, the lantern gear wheel 16 rolls on the lantern gear ring 12 which is fixedly connected to the camshaft wheel 19 via the annulus gear 7. Simultaneously, also the lantern gear wheel 26 rolls on the lantern gear ring 22 of the annulus gear 17 of the second gear stage 6, said annulus gear 17 being, in turn, directly connected to the camshaft 3. Since the lantern gear wheel 16 of the first gear stage 5 and the lantern gear wheel 26 of the second gear stage 6 are directly coupled via the eccentric portion 25 of the inner hub 8, the annulus gear 7 of the first gear stage 5, which is directly coupled to the camshaft wheel 19, and the annulus gear 17 of the second gear stage 6, which is connected to the camshaft 3, move relative to one another only by the difference between the gear ratios of the first gear stage 5 and of the second gear stage 6. Accordingly, the entire gear reduction of the lantern-type gear unit 1 results from the difference between the rolling paths of the lantern gear wheels 16, 26 of the first and second gear stages 5, 6 on the associated lantern gear rings 12, 22, whereby a high reduction gear ratio is accomplished.

During a mere transmission of a main-drive rotary movement imparted via the traction-means camshaft wheel 19, the relative position of the eccentric portion 25 of the inner hub 8 acting on the lantern gear wheels 16, 26 will not be changed if self-locking through the gear unit 1 should exist. Accordingly, the rotor of the electric motor and the camshaft 3 will rotate at the speed of the camshaft wheel 19.

### LIST OF REFERENCE NUMERALS

1: lantern-type gear unit
2: camshaft adjuster
3: camshaft
4: valve cam
5: first gear stage
6: second gear stage
7: annulus gear
8: inner hub
9: drive gear
10: double ball bearing
11: base body
12: lantern gear ring
13: bolt holders
14: bolts
15: first circumferential contour
16: lantern gear wheel (first gear stage)
17: annulus gear
18: chain wheel toothing
19: camshaft wheel for traction means
20: lantern gear ring reception means
21: base body
22: lantern gear ring
23: fixing screws
24: end flange of the camshaft
25: eccentric portion
26: lantern gear wheel (second gear stage)
27: radial reception means
28: eccentric bearing
29: mounting hole
30: first circumferential surface
31: bolt holes
32: bolt hole eyes
33: protruding areas
34: recessed areas
35: second circumferential contour
36: wave crests
37: wave troughs
38: radial connection surface
D: axis of rotation
E: eccentric axis
ε: eccentricity

1. A lantern-type gear unit comprising at least two meshing gear wheels, a first gear wheel being configured as a toothed lantern gear wheel and a second gear wheel including a lantern gear ring that engages with the lantern gear wheel, said lantern gear ring comprising at least one first annular bolt holder and a plurality of bolts arranged on the boundary of the bolt holder, wherein the annular bolt holder has, together with the bolts, a circumferential contour that is overlap-free with respect to the lantern gear wheel in an axially parallel direction, so that the annular bolt holder can, together with the bolts, be assembled with the lantern gear wheel in an axially parallel direction.

2. The lantern-type gear unit according to claim 1, wherein each bolt comprises a bolt pin and at least one of a sleeve and roller, said sleeve and roller enclosing the bolt pin.

3. The lantern-type gear unit according to claim 1, wherein on a first circumferential surface facing the lantern gear wheel, the annular bolt holder has a tooth-shaped or wave-shaped contour with protruding areas and recessed areas.

4. The lantern-type gear unit according to claim 3, wherein the protruding areas of the first circumferential surface of the annular bolt holder are configured as bolt hole eyes, and the bolts being secured in position in the bolt holes of the bolt hole eyes.

5. The lantern-type gear unit according to claim 4, wherein, on the protruding areas of the first circumferential surface of the annular bolt holder, the outer diameter of the bolt hole eye is smaller than or equal to the outer diameter of the bolts.

6. The lantern-type gear unit according to claim 4, wherein the protruding areas of the first circumferential surface of the annular bolt holder extend over at least 180° of the circumference of the bolts.

7. The lantern-type gear unit according to claim 4, wherein the recessed areas of the first circumferential surface of the annular bolt holder are recessed more deeply than the tip circle of the lantern gear wheel engaging with the lantern gear ring.

8. The lantern-type gear unit according to claim 4, wherein the recessed areas of the first circumferential surface of the annular bolt holder are recessed more deeply than the midpoint circle of the bolts on the annular bolt holder.

9. The lantern-type gear unit according to claim 1, wherein the second gear wheel additionally comprises a base body with a radial lantern gear ring reception means, so that the annular bolt holder can, together with the bolts, be mounted in the radial lantern gear ring reception means of the base body in an axially parallel direction.

10. The lantern-type gear unit according to claim 9, wherein the radial lantern gear ring reception means comprises a circumferentially radial extending connection surface, the lantern gear ring being connected to the base body in a rotationally fixed manner via the circumferentially radial extending connection surface.

11. The lantern-type gear unit according to claim 10, wherein the circumferentially radial extending connection surface of the base body extends parallel to the axis of the second gear wheel.

12. The lantern-type gear unit according to claim 10, wherein the annular bolt holder of the lantern gear ring has a second circumferential surface, which is in form-fit or force-fit contact with the circumferentially radial extending connection surface of the base body so as to connect the base body and the lantern gear ring in a rotationally fixed manner.

13. The lantern-type gear unit according to claim 12, wherein the second circumferential surface of the annular bolt holder has a wave-shaped profile.

14. The lantern-type gear unit according to claim 1, wherein the lantern gear ring is provided with additional annular bolt holders, the bolts being positioned between the annular bolt holders arranged in parallel spaced relationship with one another.

15. The lantern-type gear unit according to claim 1, wherein the thickness of the lantern gear wheel is larger than the length of the portions of the bolts protruding from the at least one first annular bolt holder.

16. The lantern-type gear unit according to claim 1, wherein the gear unit is configured such that it comprises at least two stages with at least two lantern gear wheels and at least two lantern gear rings, which each engage with one of the lantern gear wheels, the lantern gear rings each comprising at least one first annular bolt holder and a plurality of bolts, and the annular bolt holder and the bolts of the lantern gear rings having, in an axially parallel direction, an overlap-free circumferential contour with respect to the lantern gear wheel engaging with the respective lantern gear ring.

17. A camshaft adjuster for an internal combustion engine with a lantern-type gear unit comprising at least two meshing gear wheels, a first gear wheel being configured as a toothed lantern gear wheel and a second gear wheel including a lantern gear ring that engages with the lantern gear wheel, said lantern gear ring comprising at least one first annular bolt holder and a plurality of bolts arranged on the boundary of the bolt holder, wherein the annular bolt holder has, together with the bolts, a circumferential contour that is overlap-free with respect to the lantern gear wheel in an axially parallel direction, so that the annular bolt holder can, together with the bolts, be assembled with the lantern gear wheel in an axially parallel direction.
